(19) United States
(12) Patent Application Publication
(10) Pub. No.: US 2024/0237153 A1
(43) Pub. Date: Jul. 11, 2024

(54) CONTACTING AN ELECTRICALLY CONDUCTIVE PAPER LAYER

(71) Applicants: Michael Pfeifer, Gersthofen (DE); Martin Staiger, Westerstetten (DE)

(72) Inventors: Michael Pfeifer, Gersthofen (DE); Martin Staiger, Westerstetten (DE)

(73) Assignee: SURTECO GmbH, Buttenwiesen (DE)

(21) Appl. No.: 18/404,016

(22) Filed: Jan. 4, 2024

(30) Foreign Application Priority Data
Jan. 5, 2023 (DE) 10 2023 100 236.8
Jan. 3, 2024 (EP) 24150196.4

(51) Int. Cl. H05B 3/34

(52) U.S. Cl. CPC H05B 3/34

(57) ABSTRACT

A composite body including a substrate with a front side, a rear side and an outer edge, and an electrically conductive paper layer, wherein the electrically conductive paper layer is at least partially arranged on the front side of the substrate and at least partially encompasses at least two conductive tracks. The at least two conductive tracks are at least partially arranged on the rear side and/or the outer edge of the substrate. Further described is a use of the composite body and a method for producing a composite body. Further described is a contacting device for electrically contacting an electrically conductive paper layer of a composite body.

This patent application claims the benefit of priority to European Patent Application No. 24150196.4, filed Jan. 3, 2024, and claims the benefit of priority to German Patent Application No. 10 2023 100 236.8, filed Jan. 5, 2023, the entire teachings and disclosures are incorporated herein by reference thereto.

### FIELD OF THE DISCLOSURE

The invention relates to a composite body comprising a substrate with a front side, a rear side and an outer edge, and an electrically conductive paper layer, wherein the electrically conductive paper layer is at least partially arranged on the front side of the substrate and at least partially encompasses at least two conductive tracks. The invention further relates to a use of the composite body and a method for producing a composite body. The invention further relates to a contacting device for electrically contacting an electrically conductive paper layer of a composite body.

### BACKGROUND OF THE INVENTION

It is known to make paper electrically conductive by introducing conductive particles during the manufacturing process. Electrically conductive paper is suitable for heating decorative laminate panels, for example, because it can be introduced into laminate panels and heated with electricity without major process changes. By applying suitable conductive tracks, the current can be coupled into a paper layer and distributed through the conductive particles over the surface between these conductive tracks.

One challenge, however, is the exposure and safe electrical contacting of the conductive tracks. The contacting should be as variable as possible with regard to the positioning of the contact points so that heating surfaces of different sizes can be easily assembled. In addition, the connection problem must also be considered with regard to moving parts, e.g. doors.

Attempts were made to produce composite bodies with a carrier plate and an electrically conductive paper layer applied to the front side of the carrier plate, in which recesses were formed in the carrier plate in order to insert conductive elements which are in electrical contact with the conductive tracks applied to the paper layer and can be contacted with a current source from the rear side of the carrier plate.

The recesses in the carrier plate should allow the conductor elements to be inserted as precisely as possible. In particular, it is crucial that the conductive elements are flush with the front side of the carrier plate on which the electrically conductive paper structure is laminated. In addition, the positioning of the recesses must be precisely aligned with the conductive tracks applied to the paper layer. For example, the recesses run precisely parallel to the conductive tracks of the electrically conductive paper structure on the front side of the carrier plate to be coated with the electrically conductive paper structure.

The requirements for accuracy and the associated effort involved in manufacturing the composite bodies are correspondingly high. In the known method, significant process changes are necessary in the manufacturing process of the substrates used as well as in the further processing to produce the composite body. Also, the stability of the composite body can be impaired by the recesses provided in the carrier plate. In addition, optical defects such as translucent conductor elements can occur after the composite body has been pressed.

Therefore, the object of the present invention is overcoming the disadvantages of the prior art and providing an improved composite body. In addition, an advantageous use of the composite body and an improved method for producing a composite body are also to be provided. In addition, an advantageous contacting device for electrically contacting an electrically conductive paper layer of a composite body is to be provided.

### SUMMARY OF THE INVENTION

This object is solved according to a first aspect of the present invention for a composite body comprising a substrate with a front side, a rear side and an outer edge, and an electrically conductive paper layer, wherein the electrically conductive paper layer is at least partially arranged on the front side of the substrate and at least partially encompasses at least two conductive tracks, in that the at least two conductive tracks are at least partially arranged on the rear side and/or the outer edge of the substrate.

The composite body comprises a substrate. The substrate comprises a front side, a rear side and an outer edge. The front side and the rear side of the substrate can be arranged at least substantially opposite each other. The front side and the rear side of the substrate can be connected to each other via the outer edge. For example, the outer edge extends in a direction from the front side to the rear side of the substrate. For example, the outer edge is arranged perpendicular to the front side and/or the rear side of the substrate. However, other embodiments are conceivable. The outer edge can, for example, be at least partially rounded, beveled or chamfered or include decorations. In addition, the outer edge can extend in a further direction around the circumference of the substrate. In particular, the substrate can be flat. For example, the substrate is a carrier plate. The substrate is used, in particular, to give the composite body stability.

The substrate can be a wood-based panel. Examples of wood-based panels are chipboard, chipboard substitute, plywood, MDF, HDF and coarse chipboard, in particular OSB panels. For example, the substrate is a wood-based panel produced by shredding wood and then joining the structural elements together.

It is also conceivable that the substrate is a FRP panel, an aluminum composite panel, a rubber carrier panel or a fiber cement panel. It can also be a carrier plate with a plastic-based carrier material, e.g. a plastic-based, in particular thermoplastic, carrier plate. For example, it could be a polypropylene panel, in particular a thermoplastic PP panel, a PVC panel, a WPC panel or a PET panel. A carrier plate based on bound mineral ingredients such as calcium silicate or cement is also conceivable.

The composite body and/or the substrate can, for example, have a width and/or length of 600 mm to 1800 mm. However, other widths and/or lengths are also conceivable. The width and/or length of the composite body and/or the substrate can depend on the planned use of the composite body. The width and/or length depends, in particular, on the maximum area to be heated.

An electrically conductive paper layer is arranged at least partially on the front side of the substrate. An electrically conductive paper layer is understood to be a paper layer that can conduct electrical current. In particular, the electrical conductivity of the paper layer is set in such a way that it is suitable for ensuring a sufficient supply of electrical current to heat the paper layer. In particular, the electrically conductive paper layer comprises an electrically conductive paper structure. The electrically conductive paper structure is based, for example, on cellulose-containing fibrous materials and electrically conductive fibers. The paper layer obtains its electrical conductivity, for example, by incorporating electrically conductive fibers into the paper structure of the paper layer. The conductive fibers are preferably incorporated evenly. In particular, the electrically conductive paper layer comprises a paper structure with cellulose fibers and conductive fibers.

Cellulose-containing fibrous materials can be understood to mean fibrous materials, in particular of natural origin, which are preferably selected from a group of fibrous materials comprising cellulose, wood fibers, semi-cellulose, thermomechanical pulp, rags or cotton fibers, chemically digested cellulose such as sulfate or sulfite pulp, mechanical pulp, chemically modified mechanical pulp, recycled fibrous materials, combinations thereof and the like.

Electrically conductive fibers can include fibers made of metal, metal alloys and/or carbon. Carbon fibers are both electrically and thermally conductive. While the carbon fibers are particularly tensile in one direction, they break easily when forces are applied to them from another direction. The proportion of carbon fibers in the paper structure is, for example, greater than 35%, preferably between 45% and 85%, particularly preferably between 50% and 80%, most preferably over 50%. The advantages of an increased proportion of carbon fibers in the paper structure include improved conductivity, reduced electrical resistance and the associated higher conductivity. While cellulose-containing fibrous materials are particularly hydrophilic, the hydrophilicity of the paper layer decreases due to the carbon fibers it contains.

The electrically conductive paper layer can have a thickness of 50 μm to 250 μm, preferably 50 μm to 200 μm, particularly preferably around 170 μm. The basis weight of the electrically conductive paper layer is, for example, 60 g/m² to 200 g/m², in particular around 100 g/m², preferably before optional impregnation.

The electrically conductive paper layer can be impregnated, in particular impregnated with resin. Impregnation includes, for example, impregnating the electrically conductive paper layer with an aqueous plastic resin. For example, melamine resin, acrylate resin or phenolic resin can be used as the resin. The impregnated electrically conductive paper layer is, for example, at least partially bonded to the front side of the substrate.

It is also conceivable that the electrically conductive paper layer is not impregnated. It is conceivable that the electrically conductive paper layer could be applied, for example laminated, without prior impregnation. For example, dispersion adhesive can be used for this purpose, which penetrates at least partially into the paper structure of the electrically conductive paper layer and enables the electrically conductive paper layer to be applied, in particular laminated, to the substrate.

The electrically conductive paper layer is arranged at least partially on the front side of the substrate. In addition, the electrically conductive paper layer can be arranged at least partially on the outer edge and/or the rear side of the substrate. It is conceivable, for example, that the electrically conductive paper layer is arranged on the front side of the substrate in such a way that the electrically conductive paper layer forms an overhang. The overhang can protrude beyond the outer edge at at least one end of the substrate and be folded over onto the outer edge and optionally the rear side of the substrate, so that the electrically conductive paper layer is also arranged at least partially on the outer edge and/or rear side of the substrate. Preferably, the electrically conductive paper layer is arranged essentially over the entire front side of the substrate, i.e. over the entire surface of the front side of the substrate, and forms an overhang at at least one end of the substrate, which protrudes beyond the substrate.

The width and/or length of the electrically conductive paper layer can correspond to the width and/or length of the substrate. This allows the electrically conductive paper layer to be arranged on the front side of the substrate in such a way that the paper layer is flush with the outer edge of the substrate over the width and/or length of the substrate. For example, the electrically conductive paper layer and the substrate have a width of 600 mm to 1800 mm. Preferably, however, the electrically conductive paper layer has a greater width and/or length than the substrate. For example, the length of the electrically conductive paper layer is greater than the length of the substrate. It is also conceivable that the width of the electrically conductive paper layer is greater than the width of the substrate. The width and/or length of the electrically conductive paper layer protruding beyond the substrate can provide an overhang in particular a width and/or length overhang. After the electrically conductive paper layer has been applied, preferably over the entire surface, to the front side of the substrate, the width and/or length overhang thus extends beyond the outer edge of the substrate at at least one end of the substrate. This allows the overhang of the electrically conductive paper layer to be folded over onto the outer edge and/or the rear side of the substrate. The electrically conductive paper layer can thus at least partially encase the substrate. The dimensions of the substrate can be taken into account when manufacturing the electrically conductive paper layer. Heating surfaces of different sizes can be easily assembled. In this way, an advantageous composite body with an electrically conductive paper layer is provided in a constructively favorable manner.

Placing the electrically conductive paper layer on the substrate can, for example, be understood as applying it. It is conceivable, for example, that the electrically conductive paper layer is applied directly to the front side and optionally the outer edge and/or rear side of the substrate. Placing the electrically conductive paper layer on the substrate, in particular the front side of the substrate, can include, for example, laminating, laminating and/or gluing the electrically conductive paper layer. The electrically conductive paper layer, in particular the paper structure, preferably has a high degree of mobility, in particular deformability. This makes the use of the electrically conductive paper layer in the composite body particularly advantageous. The flexibility of the material means that—as with normal paper—almost any shape can be created and, in particular, folding over is possible.

The composite body can also preferably comprise at least one decorative layer. In particular, the decorative layer can be applied to the side of the electrically conductive paper layer facing away from the substrate. The decorative layer can, for example, be applied to the substrate after or at the same time as the electrically conductive paper layer. A decorative paper or a decorative (finish) film, for example, may be suitable as a decorative layer. The decorative layer can be impregnated, printed and/or coated as required. For example, lamination with thermoplastic films such as polypropylene, HDPE, PET or PVC is conceivable.

The electrically conductive paper layer at least partially encompasses at least two conductive tracks. Current can be effectively coupled into the electrically conductive paper layer via the at least two conductive tracks. Current coupled into the conductive tracks can be distributed over the surface of the electrically conductive paper layer between the conductive tracks. In this way, a heatable surface is formed between the conductive tracks.

The at least two conductive tracks are arranged at least partially on the rear side and/or the outer edge of the substrate. The conductive tracks can be partially exposed or completely enclosed by the electrically conductive paper layer. The at least two conductive tracks can be arranged so that they can be contacted via the outer edge and/or the rear side of the substrate. In particular, the at least two conductive tracks are arranged on the rear side and/or the outer edge of the substrate in such a way that the conductive tracks can be contacted on the rear side and/or the outer edge of the substrate. The at least two conductive tracks can, for example, be arranged completely on the rear side or the outer edge of the substrate. It is also conceivable that the at least two conductive tracks are arranged at least partially on the front side of the substrate and at least partially on the rear side and/or the outer edge of the substrate.

It has been shown that an at least partial arrangement of the at least two conductive tracks on the rear side and/or the outer edge of the substrate can ensure simple, safe and permanent electrical and mechanical contacting of the electrically conductive paper layer in the case of rigid and movable built-in parts. Due to the at least partial arrangement of the conductive tracks on the rear side and/or outer edge of the substrate, they can be contacted easily via the rear side and/or outer edge of the substrate. By contacting the conductive tracks via the rear side or the outer edge of the substrate, the visibility of the contacting when viewing the front side of the composite body can be avoided. In addition, the at least partial arrangement of the conductive tracks on the rear side and/or the outer edge of the substrate allows contacting via this without the need to adapt the substrate, for example by introducing recesses, or additional elements, for example conductor elements, into the substrate. Known substrates can be used in the manufacture of the composite body without having to be specially adapted. The composite body also has particularly good stability, as the substrate that provides stability does not need to be changed for contacting the electrically conductive paper layer. In particular, no recesses need to be made in the substrate to enable contacting of the electrically conductive layer applied to the front side in the first place. Additional conductive elements are also not required, which also results in a weight advantage. Established manufacturing processes can be used to produce the composite body, such as LPL, CPL, HPL, laminating technology, direct printing, so that small quantities of the composite body can also be produced using known manufacturing processes if required. Similar to decorative paper, the electrically conductive paper layer can be introduced without additional effort as part of the usual production of composite bodies, in particular composite panels.

The conductive tracks are preferably arranged parallel to each other, in particular the conductive tracks extend parallel to each other. For example, the conductive tracks extend at least partially along the length of the electrically conductive paper layer. Preferably, the at least two conductive tracks are essentially completely enclosed by the electrically conductive paper layer. For example, the conductive tracks extend completely along the length of the electrically conductive paper layer. The electrically conductive paper layer can encompass at least two substantially parallel conductive tracks that distribute the current along the electrically conductive paper layer. An edge can be provided between the conductive tracks and the outer edge of the electrically conductive paper layer, which simplifies the production of the paper layer with the conductive tracks encompassed by it. The electrically conductive paper layer with the conductive tracks encompassed by it can be provided in the form of webs. The width of the web can, for example, be adapted to the width of the substrate. The length of the web can be trimmed depending on the dimensions of the substrate.

The conductive tracks are preferably elongated. It is conceivable that the conductive tracks protrude beyond the length or width of the electrically conductive paper layer, for example by exposing them. Preferably, however, the length of the conductive tracks corresponds at least essentially to the length or width of the electrically conductive paper layer. For example, the conductive tracks are flat so that the conductive tracks essentially form a plane with the electrically conductive paper layer. The conductive tracks can thus be advantageously processed with the electrically conductive paper layer. The conductive tracks are, for example, flat, elongated electrically conductive elements.

For example, the conductive tracks each have a width of 2 mm to 10 mm, preferably around 5 mm. The thickness of the conductive tracks can be, for example, 20 μm to 50 μm, preferably 30 μm to 40 μm, particularly preferably around 35 μm. The conductive tracks have a distance of 20 to 25 mm from the outer edge of the electrically conductive paper layer along their direction of extension, for example. This simplifies the production of the electrically conductive paper layer. The length of the conductive tracks preferably corresponds at least substantially to the length of the electrically conductive paper layer. For example, if the length of the heating paper is 1 m, the resistance measured between the two conductive tracks is 14 ohms.

The conductive tracks can comprise metal, for example copper or zinc. The use of copper is advantageous due to its particularly good conductivity. In particular, the conductive tracks comprise metal strips, metal rails or metal strips such as copper or zinc strips, rails or bands. The conductive tracks can be busbars or collecting bars. However, it is also conceivable that the conductive tracks could be wires, for example.

According to a first advantageous embodiment of the composite body, the at least two conductive tracks each comprise two ends, wherein at least one end is arranged on the rear side or the outer edge of the substrate, so that contact can be made between the conductive tracks on the rear side and/or the outer edge of the substrate. The ends of the conductive tracks can act as contact points for contacting the conductive tracks. The contacting is variable, particularly with regard to the positioning of the contact points. Preferably, both ends of the conductive tracks are arranged on the rear side or the outer edge of the substrate and can be contacted via this.

The at least one end located on the rear side or the outer edge can be exposed for contacting. Exposure can be achieved, for example, by removing the at least one end from the electrically conductive paper layer after manufacture. It is also conceivable that the at least one end is applied to the surface of the paper layer or pushed to the surface of the paper layer during the production of the electrically conductive paper layer.

The conductive tracks, in particular the ends of the conductive tracks, are contacted, for example, by a contact plate, by screw-in nuts, e.g. ramp sleeves, by connectors such as banana plugs or similar, possibly also self-locking connectors, or by means of a screw in conjunction with a cable lug. If necessary, all types of contact can be made in conjunction with a cable lug and washers. Another contacting option is based on a connection with a conductive adhesive or a soldered connection with a suitable soldering compound.

For example, the power source can provide a power supply of 12 V or more, for example 24 to 48 V and 200 to 250 W/m² with direct current or alternating current. In this way, a temperature of the electrically conductive paper layer, in particular the composite body, of 35° C. to 40° C., for example, can be achieved.

According to a further advantageous embodiment of the composite body, the electrically conductive paper layer with the at least two conductive tracks encompassed by it is arranged at least partially on the rear side and/or the outer edge of the substrate. The sections of the conductive tracks arranged on the rear side and/or the outer edge of the substrate can be at least partially, in particular essentially completely, encompassed by the electrically conductive paper layer. The electrically conductive paper layer is arranged at least partially on the front side of the substrate. In particular, it covers the entire surface. To ensure that the electrically conductive paper layer with the at least two conductive tracks encompassed by it can also be arranged at least partially on the rear side and/or the outer edge of the substrate, the electrically conductive paper layer is preferably folded over onto the outer edge and optionally the rear side of the substrate. It has been found that folding over the electrically conductive paper layer can cause electrically conductive fibers contained in the electrically conductive paper layer to break. However, this does not noticeably impair the electrical conductivity of the paper layer. On the contrary, the composite body can be produced particularly simply and easily on an industrial scale.

The electrically conductive paper layer extends, for example, from the front side of the substrate to the outer edge and/or the rear side of the substrate. The at least two conductive tracks encompassed by the electrically conductive paper layer can, for example, extend with the electrically conductive paper layer from the front side of the substrate to the outer edge and/or the rear side of the substrate. For example, the conductive tracks extend along the length of the electrically conductive paper layer, with the paper layer forming a length overhang with the conductive tracks at at least one end of the substrate, which is folded over onto the outer edge and/or the rear side of the substrate. Alternatively, it is conceivable that the electrically conductive paper layer extends from the front side of the substrate to the outer edge and/or the rear side of the substrate, while the at least two conductive tracks encompassed by the electrically conductive paper layer are arranged completely on the outer edge and/or the rear side of the substrate. For example, after the electrically conductive paper layer has been arranged on the front side of the substrate, the electrically conductive paper layer forms a width overhang at opposite ends of the substrate, with the conductive tracks encompassed by the paper layer extending along the outer edge of the substrate on one width overhang in each case, so that the conductive tracks are arranged completely on the outer edge or the rear side of the substrate after the overhang has been folded over.

It is conceivable that a decorative layer is placed on the electrically conductive paper layer arranged on the front side of the substrate. It is also conceivable to fold the decorative layer over onto the outer edge and/or the rear side of the substrate. However, the decorative layer is preferably shorter and/or narrower than the electrically conductive paper layer so that it does not completely cover the conductive tracks encompassed by it, in particular the ends of the conductive tracks to be contacted.

According to a further advantageous embodiment of the composite body, at least one of the at least two conductive tracks runs at least partially along the outer edge of the substrate. Preferably, the at least two conductive tracks run at least partially along the outer edge of the substrate. In particular, the at least two conductive tracks run along the outer edge of the substrate at opposite ends. For example, the electrically conductive paper layer is arranged on the front side of the substrate in such a way that the paper layer forms an overhang at opposite ends of the substrate, with the conductive tracks extending along the outer edge of the substrate on one overhang in each case, so that the conductive tracks are arranged in particular completely along the outer edge of the substrate after the overhang has been folded over. The conductive tracks can thus be contacted easily via the outer edge of the substrate. For example, the width of the electrically conductive paper layer between the at least two conductive tracks essentially corresponds to the width of the substrate. Preferably, the width of the electrically conductive paper layer between the at least two conductive tracks is greater to the extent that this is advantageous for folding over the paper layer in such a way that the conductive tracks lie flat along the outer edge of the substrate.

According to a further advantageous embodiment of the composite body, the at least two conductive tracks run from the front side to the rear side of the substrate. In particular, the at least two conductive tracks run from the front side over the outer edge to the rear side of the substrate. Since the at least two conductive tracks are arranged not only on the front side, but also at least partially on the rear side of the substrate, contacting the conductive tracks with a current source is simplified. The conductive tracks can thus be contacted via the rear side of the substrate. For example, the conductive tracks are arranged essentially over the entire length of the front side of the substrate. They can only be partially arranged on the rear side of the substrate.

For example, the electrically conductive paper layer with the at least two conductive tracks encompassed by it runs from the front side to the rear side of the substrate. The electrically conductive paper layer and the at least two conductive tracks encompassed by it are preferably arranged at least partially on the front side and the rear side of the substrate, wherein the electrically conductive paper layer with the at least two conductive tracks encompassed by the electrically conductive paper layer runs from the front side to the rear side of the substrate. The electrically conductive paper layer with the at least two conductive tracks runs in particular from the front side to the rear side of the substrate in such a way that the conductive tracks can be contacted with a current source from the rear side of the substrate. For example, the electrically conductive paper layer with the at least two conductive tracks encompassed by it runs over an outer edge of the substrate from the front side to the rear side of the substrate. This makes it particularly easy to manufacture the composite body.

The at least two conductive tracks preferably extend along the length of the electrically conductive paper layer. The length of the conductive tracks preferably corresponds essentially to the length of the electrically conductive paper layer. The length of the electrically conductive paper layer and the at least two conductive tracks is preferably greater than the length of the substrate. In particular, the electrically conductive paper layer together with the conductive tracks encompassed by it, for example due to the protruding length of the electrically conductive paper layer with the at least two conductive tracks, forms an overhang which can be folded over onto the rear side of the substrate. The electrically conductive paper layer encompasses the at least two conductive tracks at least substantially completely, for example, and is applied to the front side of the substrate in such a way that the electrically conductive paper layer with the at least two conductive tracks forms an overhang at the outer edge of the substrate in the longitudinal direction, in particular in the machine running direction of the laminating system. After folding, the overhang extends in particular from the front side over an outer edge to the rear side of the substrate. This makes it possible to produce the composite body in a particularly simple way that is easy to carry out on an industrial scale. The electrically conductive paper layer with the conductive tracks encompassed by it can be provided in the form of webs. The electrically conductive paper layer can be applied to the substrate using conventional process steps without the need for precise coordination with other contact elements.

According to a further advantageous embodiment of the composite body, the at least two conductive tracks are at least partially applied to the electrically conductive paper layer. In particular, the conductive tracks are applied to the side of the electrically conductive paper layer facing the substrate. For example, the conductive tracks can be printed, coated or vapor-deposited on the paper layer. Printed, coated or vapor-deposited conductive tracks are particularly advantageous because they do not represent a major barrier during impregnation and are no longer visible in the finished decorative panel. In addition, corresponding electrically conductive paper layers encompassing at least two conductive tracks can also be produced on a large scale in a particularly simple manner. In particular, the conductive tracks can be applied to the paper layer by electrochemical deposition of metal, especially copper, on the surface of the paper layer.

According to a further advantageous embodiment of the composite body, the at least two conductive tracks are at least partially embedded in the electrically conductive paper layer. During the production of the electrically conductive paper layer, for example, metal strips, in particular copper strips, can be inserted into the paper layer. The conductive tracks can, for example, be at least partially surrounded on all sides by the electrically conductive paper structure. The electrically conductive paper layer with the at least partially embedded conductive tracks can be further processed particularly easily. In particular, the processing of the electrically conductive paper layer can be integrated into existing production processes without significant intervention. The conductive tracks embedded in the electrically conductive paper layer can neither be seen nor felt after lamination under a decorative paper. In particular, the conductive tracks do not cause any difference in thickness in the electrically conductive paper layer.

According to a second aspect, the said object is solved by a use of the composite body according to the first aspect for heating applications, for example as a heating element, preferably in a piece of furniture, a wall, a floor, a ceiling, a door, a window profile or a panel. The composite body comprising the electrically conductive paper layer can be used in particular as a heating element in floors, walls, furniture, in particular tabletops, heating plates, heating mats, car interior heaters, in particular door, seat, dashboard heaters or combinations thereof. It is conceivable, for example, that the composite body could be used as a tabletop. The front side of the composite body with the electrically conductive paper layer could form the underside of a desk, for example, in order to generate heat downwards. Contact via the outer edge of the composite body is particularly advantageous here. Similar to decorative paper, the electrically conductive paper layer can be inserted without additional effort as part of the usual production of composite bodies.

It is also conceivable, for example, to use the composite body in a low-energy house, a tiny house, in a caravan, on a houseboat and/or in a vehicle, e.g. as underfloor heating, ceiling heating, wall heating, smart heating in the sleeping area, general heating of the wet room to prevent mold growth and/or to prevent condensation. In principle, all potential areas of application for panel heating, especially with wood-based materials, are conceivable. The composite body can also be used, for example, to shield against radiation such as electromagnetic radiation.

According to a third aspect, said object is solved by a method for producing a composite body, in particular a composite body according to the first aspect, comprising the steps of:
providing a substrate with a front side, a rear side and an outer edge;
providing an electrically conductive paper layer, wherein the electrically conductive paper layer at least partially encompasses at least two conductive tracks; and
arranging the electrically conductive paper layer at least partially on the front side of the substrate;
   in that the at least two conductive tracks are at least partially arranged on the rear side and/or the outer edge of the substrate.

The electrically conductive paper layer is applied at least partially to the front side of the substrate. It is conceivable that the electrically conductive paper layer is applied to the entire front side of the substrate, i.e. that the entire front side of the substrate is covered with the electrically conductive paper layer.

The electrically conductive paper layer encompasses at least two conductive tracks, at least partially. For example, the conductive tracks are at least partially applied to and/or embedded in the electrically conductive paper layer. By arranging the conductive tracks at least partially on the rear side and/or the outer edge of the substrate, they can be contacted advantageously. In particular, the conductive tracks are arranged in such a way that they can be contacted on the rear side and/or the outer edge of the substrate.

According to a first advantageous embodiment of the method, the electrically conductive paper layer is arranged on the front side of the substrate in such a way that the electrically conductive paper layer with the at least two conductive tracks has an overhang over the outer edge of the substrate, the method further comprising:
folding over the overhang of the electrically conductive paper layer encompassing the at least two conductive tracks, so that the electrically conductive paper layer with the at least two conductive tracks is arranged at least partially on the rear side and/or the outer edge of the substrate.

The electrically conductive paper layer with the at least two conductive tracks is arranged in such a way that an overhang is formed over the outer edge at at least one end of the substrate. The overhang is formed, for example, over the width and/or length of the substrate. It is also conceivable that an overhang is formed over the outer edge at each of two opposite ends of the substrate. The overhang preferably at least partially encompasses the at least two conductive tracks. The method comprises folding over the overhang of the electrically conductive paper layer encompassing the at least two conductive tracks. The folding is carried out, for example, perpendicular to the direction in which the at least two conductive tracks extend. It is also conceivable that the folding is carried out parallel to the direction in which the conductive tracks extend. By folding over the overhang, the at least two conductive tracks can at least partially reach the outer edge and/or the rear side of the substrate.

For example, the electrically conductive paper layer and the at least two conductive tracks extend essentially over the entire length of the substrate. In addition, the electrically conductive paper layer and the at least two conductive tracks form a length overhang over the outer edge at at least one end of the substrate. The folding of the length overhang of the electrically conductive paper layer encompassing the at least two conductive tracks takes place perpendicular to the direction in which the at least two conductive tracks extend. In particular, the conductive tracks extend parallel to each other along the length of the electrically conductive paper layer. The overhang is preferably folded over an outer edge onto the rear side of the substrate. For example, the electrically conductive paper layer with the at least two conductive tracks encompassed by it is folded over by 90° from the front side over the outer edge of the substrate and by a further 90° onto the rear side of the substrate. In particular, the folding is carried out in such a way that the electrically conductive paper layer with the at least two conductive tracks is at least partially arranged on the front side and the rear side of the substrate. Preferably, the length overhang of the electrically conductive paper layer encompassing the at least two conductive tracks is folded over in such a way that the electrically conductive paper layer with the at least two conductive tracks extends at least partially from the front side to the rear side, in particular over an outer edge, of the substrate.

Alternatively, it is conceivable that the electrically conductive paper layer forms at least one overhang over the outer edge of the substrate parallel to the direction in which the at least two conductive tracks extend. Preferably, the electrically conductive paper layer forms an overhang over the outer edge of the substrate parallel to the direction in which the at least two conductive tracks extend at opposite ends of the substrate. The at least two conductive tracks can be encompassed by this overhang so that they lie completely on the outer edge of the substrate after the electrically conductive paper layer has been folded over, for example. This makes it easy to make contact via the outer edge of the substrate.

According to a further advantageous embodiment, the method comprises impregnating the electrically conductive paper layer. In particular, the electrically conductive paper layer is impregnated before the electrically conductive paper layer is placed on the front side of the substrate. In particular, the electrically conductive paper layer can be impregnated with resin. Impregnation includes, for example, impregnating the electrically conductive paper layer with an aqueous plastic resin. After impregnation, the electrically conductive paper layer can be applied, for example glued, to the front side of the substrate. It has been shown that the application of the electrically conductive paper layer to the substrate and the folding over of an overhang of the electrically conductive paper layer with the at least two conductive tracks encompassed by it can also be carried out after impregnation without damaging the paper layer or the heating capacity.

According to a further advantageous embodiment, the method further comprises:
contacting the at least two conductive tracks on the rear side and/or the outer edge of the substrate.

The conductive tracks, which are in particular covered by the electrically conductive paper layer, can be contacted in a simple manner on the rear side and/or the outer edge of the substrate. This advantageously provides a method for manufacturing a composite body, in particular a method for advantageously contacting the electrically conductive paper layer.

According to a fourth aspect, the said object is solved by a contacting device for electrically contacting an electrically conductive paper layer of a composite body, comprising the electrically conductive paper layer and a substrate, wherein the electrically conductive paper layer is arranged on the substrate, wherein the contacting device comprises: at least one contact element for electrically contacting a conductive track of the electrically conductive paper layer, and at least one connecting element for connecting the contacting device to the composite body, characterized in that the contact element is pressed against the conductive track of the electrically conductive paper layer by means of the connecting element when the contacting device is connected to the composite body. In particular, the contacting device is suitable for connection to the composite body. In particular, the contacting device is suitable for electrically contacting an electrically conductive paper layer of a composite body according to the first aspect. The at least one connecting element is particularly suitable for connecting the contacting device to the substrate of the composite body.

The contact element for electrically contacting a conductive track of the electrically conductive paper layer is, in particular, an electrically conductive element. The contact element is designed in particular for electrically contacting a conductive track of the electrically conductive paper layer. The contact element is, for example, flat. For example, the contact element has a T-shape. The horizontal leg of the T extends, for example, at least partially along the direction in which the conductive track of the electrically conductive paper layer extends, while the vertical leg extends perpendicular to the direction in which the conductive track extends, or vice versa. Preferably, the contact element is designed for electrical contacting by means of a connection line. In particular, in the case of a T-shaped contact element, part of the vertical T leg can be connected to a connection line. The contact element can be connected to a power source, for example, by means of a connection line. By means of the power source, current can be coupled into the conductive track of the electrically conductive paper layer via the contact element and the electrically conductive paper layer can be heated. The conductive track of the electrically conductive paper layer is preferably exposed before contact is made by the contacting device. Exposure can be achieved by scraping or grinding, for example.

The contact element is pressed against the conductive track of the electrically conductive paper layer by means of the connecting element when the contacting device is connected to the composite body, in particular the substrate of the composite body. For this purpose, the contact element is arranged in particular on a side facing the electrically conductive paper layer of the composite body. The contact element can be connected to the connecting element, in particular attached to it. It is conceivable, for example, that the contact element is connected to the connecting element with a material or force fit. The connecting element covers the contact element at least partially, for example. The connecting element is designed to connect the contacting device to the composite body.

In particular, the contacting device is suitable for a force-fit connection with the composite body, in particular the substrate of the composite body. The contact element is arranged in particular on a side of the connecting element facing the electrically conductive paper layer of the composite body and is pressed against the conductive track of the electrically conductive paper layer by means of the connecting element when the contacting device is connected to the composite body. By pressing, in particular pressing, the contact element against the conductive track of the electrically conductive paper layer, a force-fit connection may be created between the contact element and the conductive track. This is particularly advantageous in comparison to a material connection between a contact element and the conductive track. It has been recognized that in the case of a material connection, for example a soldered connection, between a conductive track of the electrically conductive paper layer and a connection line, there is a high risk that the conductive track will be torn out of the electrically conductive paper layer even with only a slight pull on the connection. This can be avoided by connecting, in particular fastening, the contacting device to the composite body, in particular the substrate of the composite body. Instead of acting on the sensitive conductive track and/or the electrically conductive paper layer, forces that act on a connection line connected to the contact element, for example, are transferred to the composite body, in particular the substrate.

According to a first advantageous embodiment of the contacting device, the connecting element for connecting the contacting device to the composite body comprises at least one fastening element for fastening the contacting device to the composite body. In particular, the connecting element for connecting the contacting device to the composite body comprises at least one fastening element for fastening the contacting device to the substrate of the composite body. The at least one fastening element is particularly suitable for force-fit connecting the connecting element to the substrate. In particular, it is conceivable that the fastening element can be connected to the substrate of the composite body through the electrically conductive paper layer. The at least one fastening element may, for example, be a screw. The fastening element can, for example, have at least one pre-drilled recess. A fastening element, for example a screw; can be inserted through the pre-drilled recess, by means of which the connecting element can be fastened to a composite body. The pre-drilled recess can be used in particular to avoid stress cracks.

According to a further advantageous embodiment of the contacting device, the connecting element for connecting the contacting device to the composite body comprises a connecting body. The connecting body presses the contact element against the conductive track of the electrically conductive paper layer when the contacting device is connected to the composite body. In particular, the connecting body can be connected to the composite body by means of the at least one fastening element. The connecting body is, for example, plate-shaped or block-shaped. For example, the connecting body is a plate or a block. Suitable materials for the connecting body include plastics, especially transparent plastics. The connecting body is made of epoxy resin, in particular transparent epoxy resin, for example. Transparent plastics, in particular transparent epoxy resin, in particular allow easy positioning of the contact element relative to the conductive track of the electrically conductive paper layer, especially in the case that the contact element is arranged on a side of the connecting body facing the conductive track. In particular, the connecting body is wider than the conductor track of the electrically conductive paper layer. In particular, the connecting body can be connected to the composite body on both sides next to the conductive track of the electrically conductive paper layer.

According to a further advantageous embodiment of the contacting device, the contact element can be connected to a connection line. In particular, the contact element can be detachably connected to a connection line. The contact element and/or the connection line preferably comprise a connection element by means of which the contact element and the connection line can be connected, in particular detachably connected. This enables particularly quick and easy contacting of the electrically conductive paper layer, especially after installation of the composite body, for example as a wall element in a caravan. It is conceivable, for example, that the contact element or the connection line comprises a plug or a terminal, while the other element is designed for connection to the plug or the terminal.

Further embodiments and advantages of the invention are explained in the following detailed description of some exemplary embodiments of the present invention in conjunction with the drawing.

### BRIEF DESCRIPTION OF THE DRAWINGS

In the following, embodiments and variants of the invention are explained in more detail with reference to the drawing. The aspects of the disclosure can best be understood from the following detailed description in conjunction with the accompanying figures. The figures are schematic and simplified, showing only details to improve the understanding of the claims, while other details are omitted. The same reference numerals are used throughout for identical or corresponding parts. The individual features of each aspect may be combined with any or all of the features of the other aspects. These and other aspects, features and/or technical effects are shown in and illustrated by the figures described below:

FIG. 1 is a schematic top view of an electrically conductive paper layer encompassing two conductive tracks:

FIG. 2 is a schematic representation of a cross-section of the electrically conductive paper layer, which encompasses two conductive tracks:

FIGS. 3a, 3b are schematic representations of embodiments of a composite body according to the first aspect:

FIG. 4 is a flow diagram of a first embodiment of a method according to the third aspect:

FIGS. 5a, 5b are exploded views of an embodiment of a composite body according to the first aspect: and

FIG. 6 is a schematic representation of a further embodiment of a composite body according to the first aspect:

FIG. 7a, 7b, 7c are schematic representations of an embodiment of a contacting device according to the fourth aspect: and

FIG. 8 is a schematic representation of an embodiment of a contacting device according to the fourth aspect, which is connected to a composite body according to the first aspect.

### DETAILED DESCRIPTION

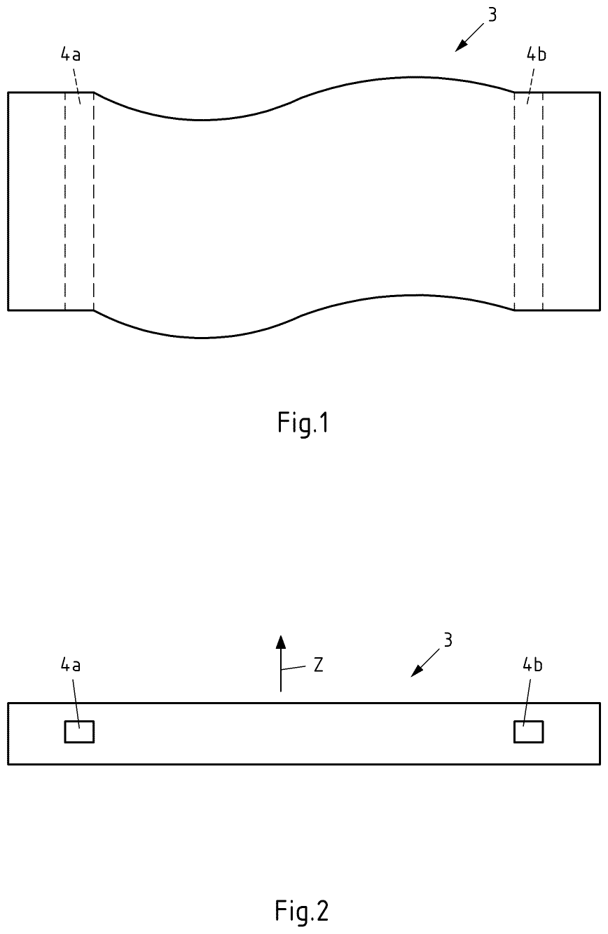

FIG. 1 is a schematic representation of an electrically conductive paper layer 3. The electrically conductive paper layer 3 encompasses two conductive tracks 4a, 4b, which are arranged parallel to each other. The conductive tracks 4a, 4b are arranged in the longitudinal direction of the electrically conductive paper layer 3. The conductive tracks 4a, 4b have a distance of 20 to 25 mm from the outer edge of the electrically conductive paper layer 3 along their direction of extension, for example. The width of the conductive tracks 4a, 4b is 5 mm. The length of the conductive tracks 4a, 4b depends on the length of the electrically conductive paper layer 3.

FIG. 2 is a cross-section of the electrically conductive paper layer 3 encompassing the two conductive tracks 4a, 4b. The conductive tracks 4a, 4b are embedded in the electrically conductive paper layer 3. In an alternative embodiment, the conductive tracks 4a, 4b can be applied to the electrically conductive paper layer 3. They can be applied, for example, by printing, coating or vaporizing the paper layer 3 with conductive materials.

The width of the electrically conductive paper layer 3 is 600 mm, the height is 170 μm. The height of the conductive tracks 4a, 4b is 35 μm, the conductive tracks 4a, 4b being embedded approximately centrally in relation to the height of the electrically conductive paper layer 3. However, it is conceivable that the conductive tracks 4a, 4b have been embedded in the electrically conductive paper layer 3 in such a way that they reach the surface of the electrically conductive paper layer 3 at their ends (not shown) in the z-direction, so that they can be contacted in a particularly simple manner.

The electrically conductive paper layer 3 shown in FIGS. 1 and 2 can, for example, be arranged on a substrate to form a composite body. The conductive tracks 4a, 4b can be copper conductive tracks, for example.

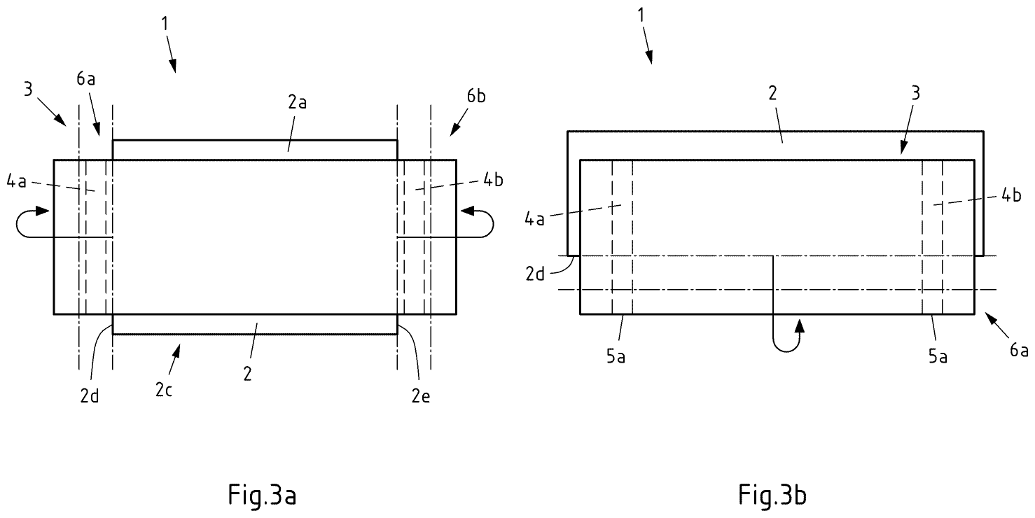

FIG. 3a is a composite body 1 with an electrically conductive paper layer 3, which is partially arranged on the front side 2a of a substrate 2. The electrically conductive paper layer 3 forms an overhang 6a, 6b over the outer edge 2c of the substrate 2 at opposite ends 2d, 2e of the substrate 2. The overhang 6a, 6b completely encloses the two conductive tracks 4a, 4b encompassed by the electrically conductive paper layer 3. At the dot-dash lines shown, the overhang 6a, 6b is folded over the outer edge 2c of the substrate 2 at the opposite ends 2d, 2e, as shown by the arrows. By folding over, the conductive tracks 4a, 4b are arranged at the opposite ends 2d, 2e on the outer edge 2c of the substrate 2. Here, the conductive tracks 4a, 4b run at least partially along the outer edge 2c of the substrate 2. In this way, the conductive tracks 4a, 4b can be contacted advantageously via the outer edge 2c of the substrate 2. A further part of the electrically conductive paper layer 3 can be folded over onto the rear side of the substrate 2, as shown by the outer dot-dash lines.

FIG. 3b is another composite body 1 with an electrically conductive paper layer 3. The electrically conductive paper layer 3 is arranged on the front side 2a of the substrate 2 in such a way that an overhang 6a is formed over a lower end 2d of the substrate 2 via the outer edge 2c. The electrically conductive paper layer 3 with the conductive tracks 4a, 4b encompassed by it is folded over the outer edge 2c of the substrate 2 perpendicular to the direction in which the conductive tracks 4a, 4b extend, so that the electrically conductive paper layer 3 with the conductive tracks 4a, 4b encompassed by it runs from the front side 2a over the outer edge 2c to the rear side 2b of the substrate 2. In this way, the ends Sa of the conductive tracks 4a, 4b can advantageously be contacted on the rear side 2b of the substrate 2.

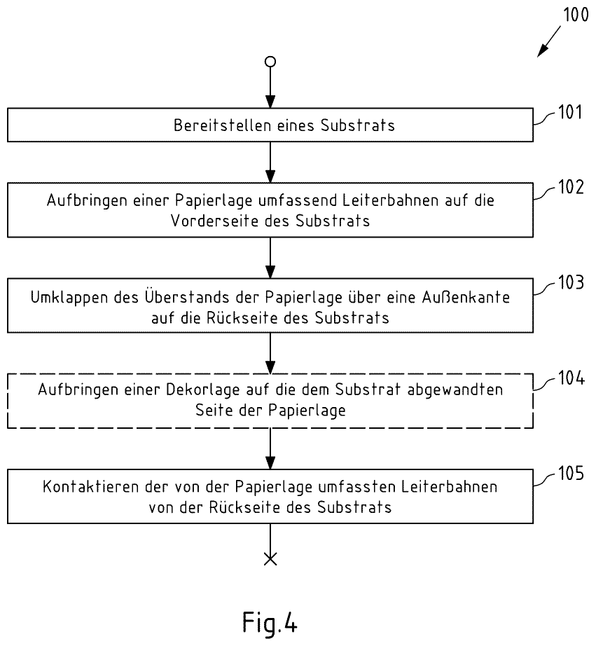

In FIG. 4, an exemplary sequence of a method 100 according to the third aspect is shown in a flow chart. In the first step 101, a substrate 2 is provided. The substrate 2 has a front side 2a, a rear side 2b and an outer edge 2c. In step 102, a previously provided electrically conductive paper layer 3 is applied to the front side 2a of the substrate 2. The electrically conductive paper layer 3 encompasses two conductive tracks 4a, 4b. The conductive tracks 4a, 4b can, for example, be applied to the electrically conductive paper layer 3 or embedded in it. The electrically conductive paper layer 3 may, for example, have been impregnated.

For example, the electrically conductive paper layer 3 is applied over the entire surface of the front side 2a of the substrate 2, so that the front side 2a of the substrate 2 is completely covered with the electrically conductive paper layer 3. However, the length of the electrically conductive paper layer 3 and the conductive tracks 4a, 4b encompassed by it is greater than the length of the substrate 2 and the electrically conductive paper layer 3 thus forms an overhang 6a, 6b with the conductive tracks 4a, 4b encompassed by it at opposite ends 2d, 2e of the substrate 2.

In step 103, the overhang 6a, 6b of the electrically conductive paper layer 3 is folded over the outer edge 2c of the substrate 2 onto the rear side 2b of the substrate 2. The electrically conductive paper layer 3 thus at least partially covers the outer edge 2c and the rear side 2b of the substrate 2. The conductive tracks 4a, 4b are also arranged at least partially on the outer edge 2c and the rear side 2b of the substrate 2 and can be contacted via the rear side 2b of the substrate 2.

In an optional step 104, a decorative layer 7 is applied to the side of the electrically conductive paper layer 3 facing away from the substrate 2. The application of the decorative layer 7, i.e. step 104, can take place at the same time as the application of the electrically conductive paper layer 3, i.e. step 102. The application of the decorative layer 7, step 104, preferably takes place before contacting the conductive tracks 4a, 4b in step 105. However, the application of the decorative layer 7, step 104, can also take place after contacting, step 105, or at the same time as this.

In step 105, the conductive tracks 4a, 4b encompassed by the electrically conductive paper layer 3 are contacted with a current source from the rear side 2b of the substrate 2. The conductive tracks 4a, 4b are contacted, for example, by means of a plug connector or by means of a screw in conjunction with a cable lug.

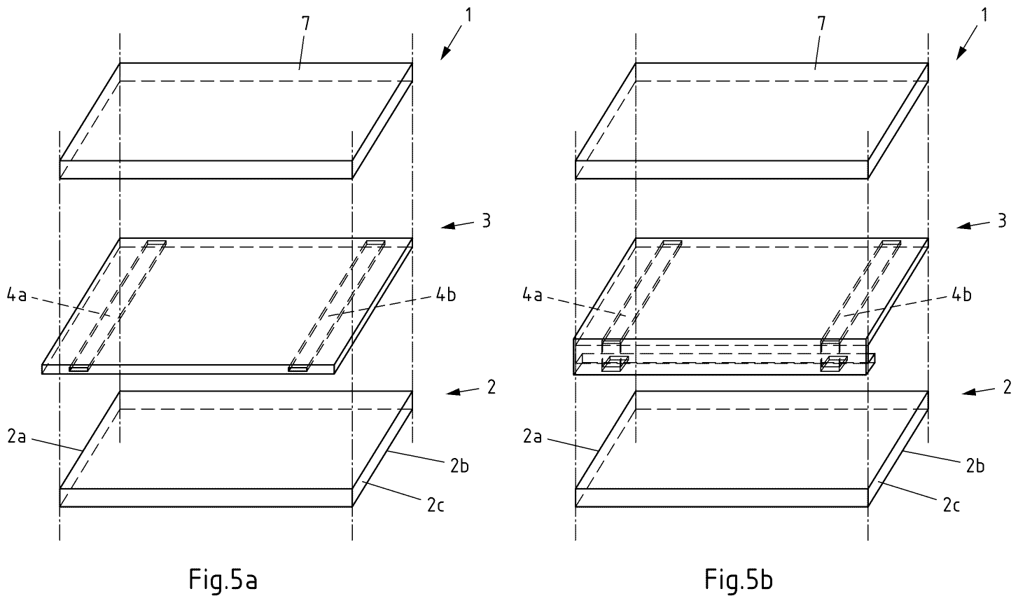

FIG. 5a is a substrate 2, an electrically conductive paper layer 3 and a decorative layer 7 of a composite body 1. The electrically conductive paper layer 3 is located above the front side 2a of the substrate 2. The electrically conductive paper layer 3 has two conductive tracks 4a, 4b, which extend parallel to each other over the length of the electrically conductive paper layer 3. The length of the electrically conductive paper layer 3 and the conductive tracks 4a, 4b encompassed by it is greater than the length of the substrate 2 and the decorative layer 7. After the electrically conductive paper layer 3 has been applied to the front side 2a of the substrate 2, it protrudes with the conductive tracks 4a, 4b encompassed by it over the front end 2d of the substrate 2 over the outer edge 2c with an overhang 6a.

As shown in FIG. 5b, after the electrically conductive paper layer 3 has been applied over the entire surface of the front side 2a of the substrate 2, the overhang 6a with the conductive tracks 4a, 4b encompassed by the electrically conductive paper layer 3 was folded over so that the electrically conductive paper layer 3 with the conductive tracks 4a, 4b encompassed by it is also applied at least partially to the rear side 2b of the substrate 2. For this purpose, the electrically conductive paper layer 3 with the conductive tracks 4a, 4b encompassed by the electrically conductive paper layer 3 was first folded down at a 90° angle over the outer edge 2c of the substrate 2 and then folded back at a further 90° angle onto the rear side 2b of the substrate 2. In this way, the conductive tracks 4a, 4b are arranged at least partially on the front side 2a and at least partially on the rear side 2b of the substrate 2. In particular, the conductive tracks 4a, 4b are applied to the side of the electrically conductive paper layer 3 facing the substrate 2 and are in direct contact with the surface of the substrate 2.

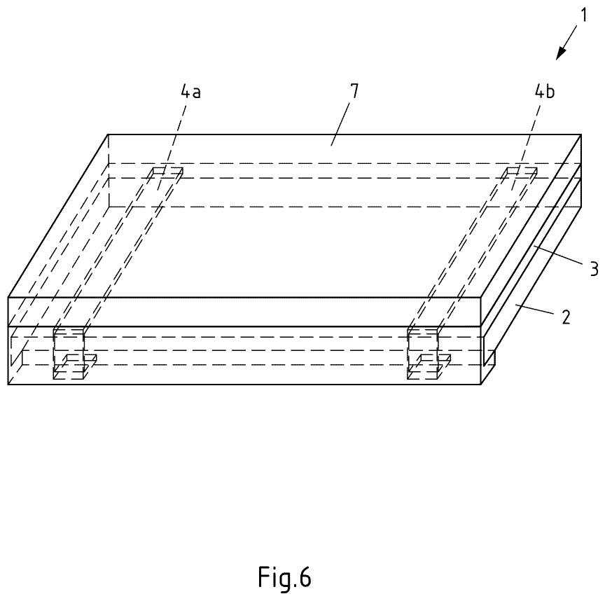

A composite body 1 is shown in FIG. 6. The composite body 1 comprises a substrate 2, an electrically conductive paper layer 3 and a decorative layer 7. The electrically conductive paper layer 3 encompasses two conductive tracks 4a, 4b, which are, in particular, embedded in the electrically conductive paper layer 3, and extends with the two conductive tracks 4a, 4b from the front side 2a of the substrate 2 over the outer edge 2c of the substrate 2 to the rear side 2b of the substrate 2. There, the conductive tracks 4a, 4b are easily accessible and can be contacted advantageously.

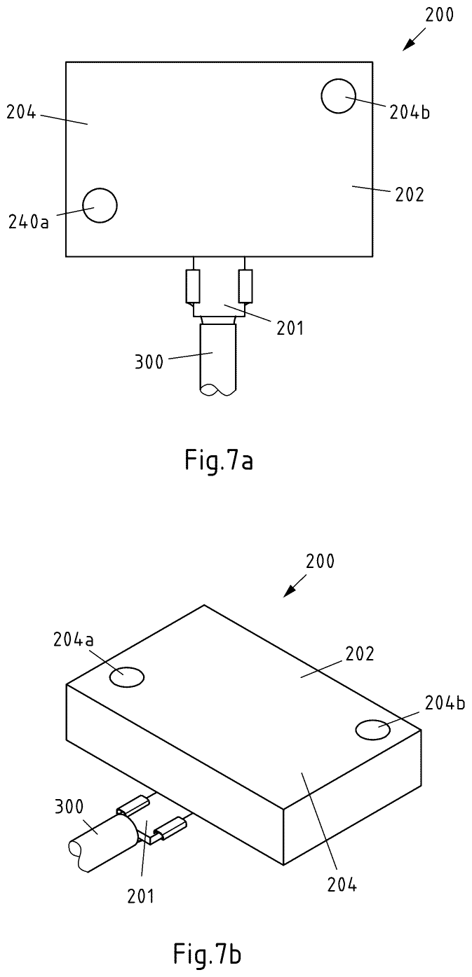

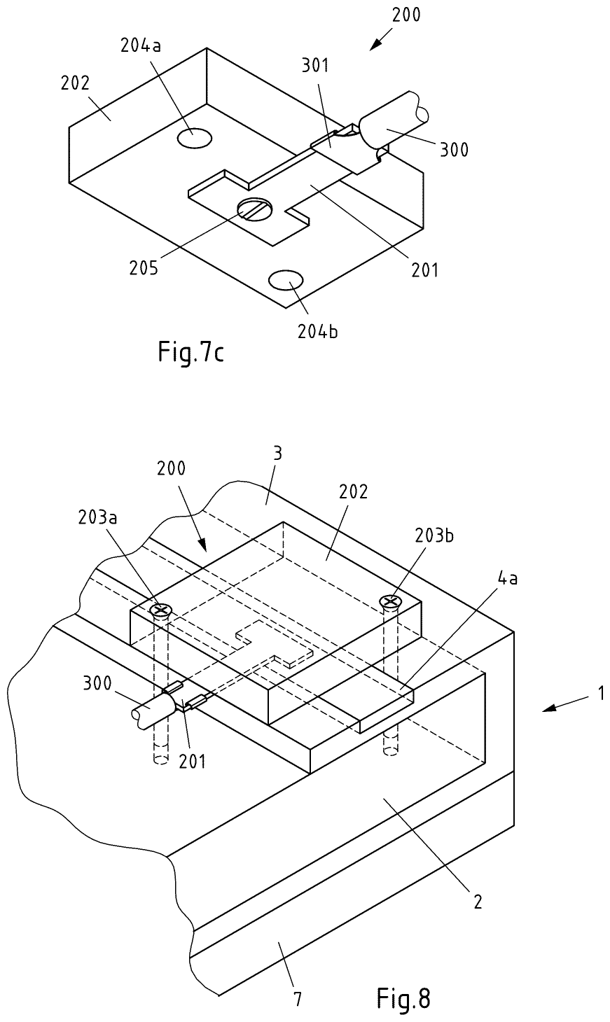

FIGS. 7a, 7b and 7c are a contacting device 200 for electrically contacting an electrically conductive paper layer of a composite body. The contacting device 200 comprises a contact element 201 for electrically contacting the electrically conductive paper layer, in particular a conductive track of the electrically conductive paper layer, and a connecting element 202 for connecting the contacting device 200 to the composite body. The connecting element 202 has a connecting body 204 made of epoxy resin in the form of a rectangular block. The contact element 201 is arranged on the bottom side of the connecting body 204 of the connecting element 202, in particular on a side facing the electrically conductive paper layer. The contact element 201 is designed as a T-shaped piece of metal and is attached to the connecting element 202 essentially in the middle by means of a screw 205. On one side of the connecting element 202, the contact element 201 protrudes beyond the connecting element 202. The projecting end of the contact element 201 is detachably connected to a connection line 300. At the connected end of the connection line 300, the connection line 300 has a connection element 301 in the form of a plug, which is plugged onto the projecting end of the contact element 201. It is also conceivable that, conversely, the contact element 201 has a connection element which can be connected to the connection line 300.

The connecting body 204 of the connecting element 202 has pre-drilled holes 204a, 204b. Fastening elements, for example screws, can be inserted through the pre-drilled holes 204a, 204b, by means of which the connecting element 202 can be fastened to a composite body. Stress cracks can be avoided by the pre-drilled holes 204a, 204b. The contact element 201 is pressed against a conductive track of an electrically conductive paper layer of a composite body by means of the connecting element 202 when the contacting device 200 is connected to the composite body. In particular, the connecting body 204 of the connecting element 202 presses the contact element 201 against the conductive track of the electrically conductive paper layer when the contacting device 200 is connected to the composite body 1.

FIG. 8 is a contacting device 200 which is connected to a composite body 1. The composite body 1 comprises a substrate 2 on which an electrically conductive paper layer 3 is arranged. The electrically conductive paper layer 3 is at least partially folded over onto the rear side of the substrate 2. The electrically conductive paper layer 3 comprises a conductive track 4a, which is arranged in the folded-over part of the electrically conductive paper layer 3 on the rear side of the substrate 2 and is at least partially exposed for contacting by means of the contacting device 200. The contacting device 200 comprises a contact element 201 for electrically contacting the conductive track 4a of the electrically conductive paper layer 3 on the rear side of the substrate 2 and a connecting element 202 for connecting the contacting device 200 to the composite body 1. The connecting element 202 comprises a connecting body 204 made of transparent epoxy resin. The contact element 201 is arranged below the connecting element 202 on the side facing the electrically conductive paper layer 3. The contact element 201 has a T-shape. In the present case, the horizontal leg of the T extends along the direction in which the conductive track 4a extends. The vertical leg of the T extends perpendicular to the direction in which the conductive track 4a extends. Part of the vertical leg of the T protrudes below the connecting element 202 for connection to a connecting line 300. The connecting element 202 and the contact element 201 rest on the electrically conductive paper layer 3 of the composite body 1 and the connecting element 202 is connected to the substrate 2 of the composite body 1 by means of fastening elements 203a, 203b in the form of screws. The contact element 201 of the contacting device 200 is pressed against the conductive track 4a of the electrically conductive paper layer 3 by means of the connecting element 202. In this way, simple and secure contacting of the conductive track 4a of the electrically conductive paper layer 3 of the composite body 1 is made possible.

The contact element 201 of the contacting device 200 is also detachably connected to a connection line 300. The conductor track 4a of the electrically conductive paper layer 3 is connected to a current source (not shown) via the connection line 300. This can be used to couple current into the electrically conductive paper layer 3, whereby the electrically conductive paper layer 3 can be heated to 35° C. to 40° C., for example.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having.” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A composite body comprising:
a substrate with a front side, a rear side and an outer edge, and
an electrically conductive paper layer, wherein the electrically conductive paper layer is at least partially arranged on the front side of the substrate and at least partially encompasses at least two conductive tracks,
wherein
the at least two conductive tracks are at least partially arranged on the rear side and/or the outer edge of the substrate.

2. The composite body according to claim 1,
wherein
the at least two conductive tracks each comprise two ends, wherein at least one end is arranged on the rear side or the outer edge of the substrate, so that contact can be made between the conductive tracks on the rear side and/or the outer edge of the substrate.

3. The composite body according to claim 1,
wherein
the electrically conductive paper layer with the at least two conductive tracks encompassed by it is arranged at least partially on the rear side and/or the outer edge of the substrate.

4. The composite body according to claim 1,
wherein
at least one of the at least two conductive tracks runs at least partially along the outer edge of the substrate.

5. The composite body according to claim 1,
wherein
the at least two conductive tracks run from the front side to the rear side, in particular over the outer edge, of the substrate.

6. The composite body according to claim 1,
wherein
the at least two conductive tracks are at least partially applied to the electrically conductive paper layer.

7. The composite body according to claim 1,
wherein
the at least two conductive tracks are at least partially embedded in the electrically conductive paper layer.

8. A use of the composite body according to claim 1 for heating applications, for example as a heating element, preferably in a piece of furniture, a wall, a floor, a ceiling, a door, a window profile and/or a panel.

9. A method for producing a composite body, in particular a composite body according to claim 1, comprising the steps of:
providing a substrate with a front side, a rear side and an outer edge;
providing an electrically conductive paper layer, wherein the electrically conductive paper layer at least partially encompasses at least two conductive tracks; and
arranging the electrically conductive paper layer at least partially on the front side of the substrate;
wherein
the at least two conductive tracks are at least partially arranged on the rear side and/or the outer edge of the substrate.

10. The method according to claim 9,
wherein
the electrically conductive paper layer is arranged on the front side of the substrate in such a way that the electrically conductive paper layer with the at least two conductive tracks has an overhang over the outer edge of the substrate, the method further comprising:
folding over the overhang of the electrically conductive paper layer encompassing the at least two conductive tracks, so that the electrically conductive paper layer with the at least two conductive tracks is arranged at least partially on the rear side and/or the outer edge of the substrate.

11. The method according to claim 9,
wherein
the method further comprises:
impregnating the electrically conductive paper layer.

12. The method according to claim 9,
Wherein
the method further comprises:
contacting the at least two conductive tracks on the rear side and/or the outer edge of the substrate.

13. A contacting device for electrically contacting an electrically conductive paper layer of a composite body comprising the electrically conductive paper layer and a substrate, wherein the electrically conductive paper layer is arranged on the substrate, in particular of a composite body according to claim 1, the contacting device comprising:
at least one contact element for electrically contacting a conductive track of the electrically conductive paper layer, and
at least one connecting element for connecting the contacting device to the composite body, in particular to the substrate of the composite body, wherein
the contact element is pressed against the conductive track of the electrically conductive paper layer by means of the connecting element when the contacting device is connected to the composite body.

14. The contacting device according to claim 13,
wherein
the connecting element for connecting the contacting device to the composite body comprises at least one fastening element for fastening the contacting device to the composite body, in particular the substrate of the composite body.

15. The contacting device according to claim 13,
wherein
the connecting element for connecting the contacting device to the composite body comprises a connecting body, the connecting body pressing the contact element against the conductive track of the electrically conductive paper layer when the contacting device is connected to the composite body.

16. The contacting device according to claim 13,
wherein
the contact element is connectable, in particular detachably connectable, to a connection line.
